(19) United States
(12) Patent Application Publication
(10) Pub. No.: US 2003/0045336 A1
(43) Pub. Date: Mar. 6, 2003

(54) Game based on the outcomes of multiple sequential wagering events

(76) Inventor: Eric Cherry, Highland Beach, FL (US)

Correspondence Address: JEFFREY L. SNOW, KIRKPATRICK & LOCKHART LLP, 75 STATE STREET, BOSTON, MA, 02109-1808, US

(21) Appl. No.: 09/945,880

(22) Filed: Sep. 4, 2001

(51) Int. Cl. A63F 13/00

(52) U.S. Cl. 463/16

(57) ABSTRACT

In a method and apparatus for playing a game based on outcomes of multiple sequential wagering events, such as a series of horse races, players place wagers on the outcomes of the sequential wagering events. The outcomes of a plurality of the wagering events are determined. It is determined whether the wagers have a winning status for each of the plurality of the wagering events. It is also determined whether the wagers are the only wagers placed on the outcomes of the sequential wagering events having a winning status for all of the plurality of the wagering events.

### BACKGROUND OF THE INVENTION

This invention relates to a game, and in particular, a game based on the outcomes of multiple sequential wagering events.

In a typical series of sequential wagering events, such as a series of horse races run at a racetrack on a particular day, game players place wagers on the outcomes of each of the wagering events. For example, the players place wagers as to which racehorse will win each of the series of horse races. Such wagers are usually placed with respect to the horses in each race according to their post numbers.

### SUMMARY OF THE INVENTION

In general, in one aspect, the invention features a method of playing a game based on outcomes of multiple sequential wagering events. Wagers are placed on the outcomes of the sequential wagering events. The outcomes of a plurality of the wagering events are determined. It is determined whether the wagers have a winning status for each of the plurality of the wagering events. It is also determined whether the wagers are the only wagers placed on the outcomes of the sequential wagering events having a winning status for all of the plurality of the wagering events.

Implementations of the invention may also include one or more of the following features. A prize is awarded if the wagers are the only wagers placed on the outcomes of the sequential wagering events having a winning status for all of the plurality of the wagering events. The prize may be based on predetermined odds or determined on a parimutuel basis.

A monetary wager may be placed on the game. The wagers may be recorded on a ticket. The wagering events may be horse races.

In general, in another aspect, the invention features a method of playing a game based on outcomes of multiple sequential wagering events. Wagers are placed on the outcomes of the sequential wagering events. The outcomes of a plurality of the wagering events including a final wagering event are determined. It is determined whether the wagers have a winning status for each of the plurality of the wagering events including the final wagering event. A prize is awarded if the wagers have a winning status for each of the plurality of the wagering events including the final wagering event.

In general, in another aspect, the invention features a method of playing a game based on outcomes of sequential wagering events. Wagers are placed on the outcomes of the sequential wagering events. The outcome of one of the wagering events is determined. It is determined whether the wager placed on the wagering event with the determined outcome has a winning status, and if the wager does not have a winning status for the determined outcome, the wagers are eliminated from the game, or if the wager has a winning status for the determined outcome, the game is concluded if the wager is the only wager having a winning status for the determined outcome, or the outcome of the next sequential wagering event is determined if the wager is not the only wager having a winning status for the determined outcome.

Implementations of the invention may also include one or more of the following features. A prize may be awarded if the game is concluded. The prize may be based on predetermined odds or determined on a parimutuel basis. The wagers may be recorded on a ticket. The wagering events may be horse races.

In general, in another aspect, the invention features an electronic gaming device for playing a game based on outcomes of multiple sequential wagering events by a player. Using an input device, the player places wagers on the outcomes of the sequential wagering events. A processor determines the outcomes of a plurality of the wagering events, determines whether the wagers have a winning status for each of the plurality of the wagering events, and determines whether the wagers are the only wagers placed on the outcomes of the sequential wagering events having a winning status for all of the plurality of the wagering events. A display device displays the outcomes of the plurality of the wagering events.

Implementations of the invention may also include one or more of the following features. The display device may include a screen. The input device may include a keyboard or a touch-sensitive screen. A payout device may provide a prize to the player.

In general, in another aspect, the invention features a system for playing a game based on outcomes of multiple sequential wagering events by a player. Using a gaming device, the player places wagers on the outcomes of the sequential wagering events. A central processor determines the outcomes of a plurality of the wagering events, determines whether the wagers have a winning status for each of the plurality of the wagering events, and determines whether the wagers are the only wagers placed on the outcomes of the sequential wagering events having a winning status for all of the plurality of the wagering events.

Implementations of the invention may also include one or more of the following features. The gaming device may communicate with the central processor over a network, which may be the internet. The system may include a modem by which the gaming device communicates with the central processor.

The game of the present invention has the advantage that it is a simple game that can be played along with other standard wagering games.

The game of the present invention has the further advantage of allowing players to play a game based on combinations of known probabilistic events.

Other features and advantages of the invention will become apparent from the following detailed description, and from the claims.

### BRIEF DESCRIPTION OF THE DRAWINGS

FIG. 1 shows a collection of tickets evidencing wagers placed on and the outcomes of a series of horse races exemplifying the game of the present invention.

FIG. 2 is a flow chart showing a method of playing the game of the present invention with respect to a ticket containing wagers for a series of sequential wagering events.

FIG. 3 shows a system for playing the game of the present invention over a network.

FIG. 4 is a somewhat diagrammatic sketch of an electronic gaming machine for playing the game of the present invention.

### DESCRIPTION OF THE PREFERRED EMBODIMENTS

The game of the present invention involves the outcomes of multiple sequential wagering events. For example, the game may be played in conjunction with a series of horse races, e.g., sequential horse races at a racetrack on a particular day. Prior to determining the outcomes of the events, game players place wagers with a wagering authority with respect to each of the events, e.g., by purchasing a ticket from the gaming authority. The wagers for all of the sequential events may be made, e.g., prior to determining the outcome of the first event.

The game of the present invention is a high-level game that is played based on the outcomes of the multiple sequential wagering events. The status of the players' wagers corresponding to each gaming event is determined to be “winning” or “not winning” in comparison with the outcome of each event. As the outcome of each of the wagering events is determined, each ticket or wager for the high-level game is either eliminated from the high-level game if the corresponding wager placed on the event does not have a winning status, or the ticket remains uneliminated from the high-level game for determination of the next event outcome in the sequence of wagering events. The last ticket or wager that remains after all or some of the outcomes of the sequence of wagering events have been determined is the winner of the high-level game, for which a prize may be awarded by the wagering authority.

The high-level game of the present invention is a form of sequential elimination game, of the type known as “last man standing.” This means, e.g., that a winning ticket or wager for the high-level game is not necessarily the one that contains the greatest number of winning wager selections corresponding to the series of wagering events.

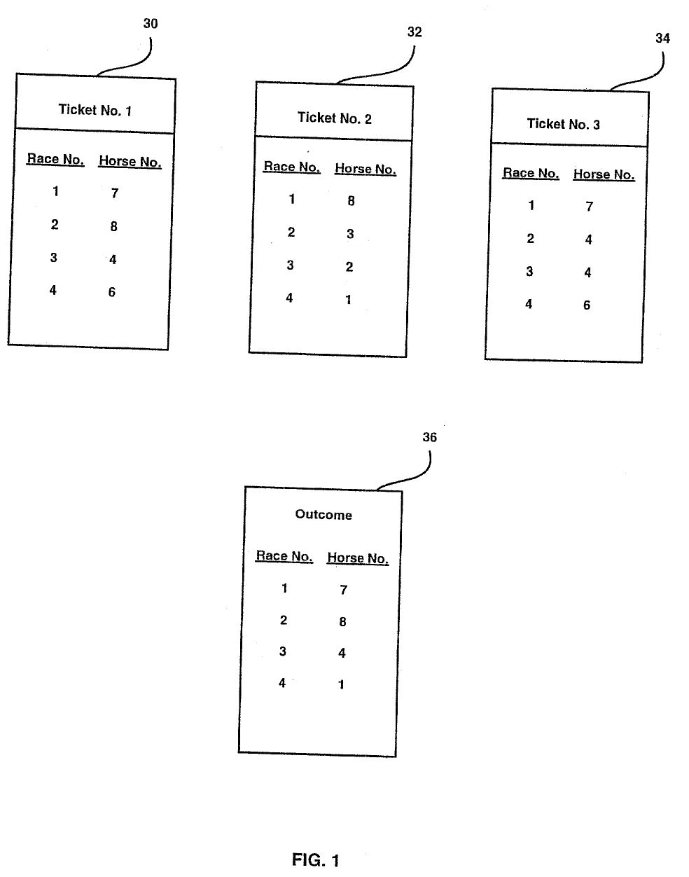

In the example of the game played with respect to a series of horse races, game players place wagers on races based on the post numbers of the horses in the race. FIG. 1 shows three wagering tickets 30, 32, 34 purchased by game players for four sequential horse races numbered 1 through 4 run at a racetrack on a particular day. For example, as shown on Ticket No. 1 (30), the game player has placed wagers that the horse having post number 7 (Horse No. 7) will win the first race (Race No. 1), that the horse having post number 8 will win the second race, etc. In each race, or wagering event, the horses compete against each other to be the first to cross the finish line. The first horse to cross the finish line is the “winner.” Wagers on horse races may also be placed for a particular horse to be the first, second or third horse to finish the race, i.e., to “win,” “place,” or “show,” respectively.

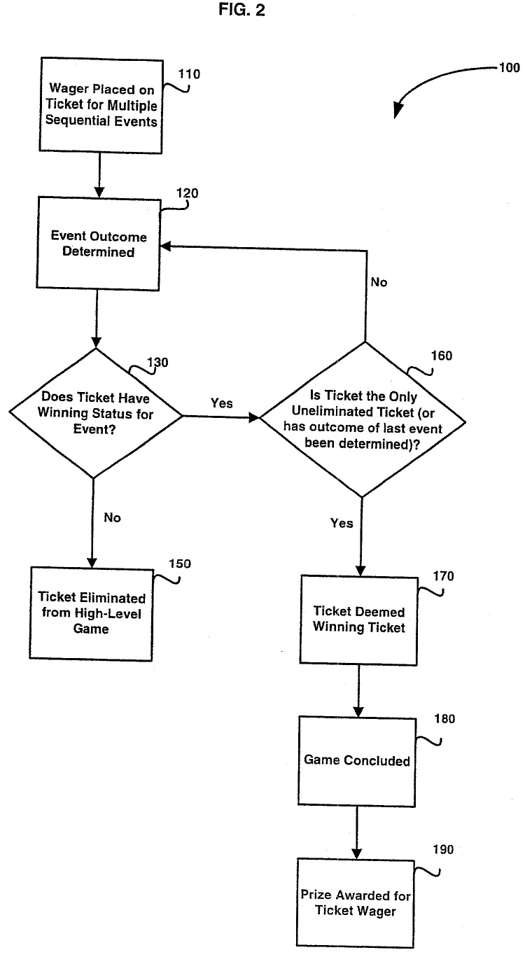

FIG. 2 is a flow chart 100 illustrating the play of the high-level game of the present invention with respect to a series of wagers placed on multiple sequential wagering events made and recorded on a ticket. Game players place their wagers on multiple sequential wagering events such as horse races, e.g., by purchasing tickets indicating the wagers (step 110). The outcome of the first event is determined, e.g., by conducting the first horse race to determine the post number of the winning horse in the first race (step 120).

The wager corresponding to the first event on each ticket is compared to the outcome of the first event to determine whether the ticket has a winning status for the first event (step 130). If the ticket has a winning status for the first event, the ticket is uneliminated from the high-level game and remains in play. If the ticket does not have a winning status for the first event, the ticket is eliminated from the high-level game (step 150).

The wagering authority also determines whether the uneliminated ticket is the only uneliminated ticket in the high-level game (step 160). If the uneliminated ticket is the only one remaining, then it is deemed the winning ticket for the high-level game (step 170), and the game is concluded (step 180). A prize may be paid for the winning ticket by the wagering authority (step 190). If the uneliminated ticket is not the only one remaining, the outcome of the next event is determined (step 120). In the event that there is more than one ticket remaining uneliminated after the outcomes of all of the sequential wagering events have been determined, each of the uneliminated tickets may be deemed a winning ticket, and the prize may be split between them (see steps 160 through 190).

The wagering authority may repeat steps 120 through 160 until there is only one uneliminated ticket in the high-level game. In the event that no ticket remains after the outcome of one of the series of events is determined, there may be no winner for that high-level game. Alternatively, in the event that no ticket remains after the outcomes of the series of events are determined, a prize may be awarded to the last ticket or tickets to be eliminated from the high-level game or to another second-best winner, e.g., the ticket or tickets containing the greatest number of winning wager selections corresponding to the series of wagering events or a participant who made wager selections for the wagering events with corresponding outcomes having the highest non-winning ranking.

In the example of FIG. 1, three tickets 30, 32, 34 are purchased for a series of four horse races numbered 1 through 4. According to outcome 36, the post number of the winning horse in the first race is number 7. By comparison to Ticket Nos. 1, 2 and 3, the players and the wagering authority determine that Ticket Nos. 1 and 3 contain wagers placed on the winning horse, and those tickets are deemed to have a winning status and remain uneliminated in the high-level game for determination of the outcome of the next event in the sequence of wagering events. However, Ticket No. 2 does not contain a wager placed on the winning horse, and as a result, is deemed not to have a winning status and is eliminated from the high-level game.

According to outcome 36, the post number of the winning horse for the second race is number 8. By comparison to Ticket Nos. 1 and 3, Ticket No. 1 contains a wager placed on the winning horse, and is deemed to have a winning status and remains uneliminated in the high-level game. Ticket No. 3 does not contain a wager placed on the winning horse, and as a result, is deemed not to have a winning status and is eliminated from the high-level game. Ticket No. 2 had been eliminated from the high-level game after the first race. Since Ticket No. 1 is the only ticket that is not eliminated after the second race, it is deemed the winning ticket for the high-level game, and Ticket No. 1 may be redeemed with the wagering authority for a prize.

The game of the present invention may be played by placing a further wager with the wagering authority on the high-level game in addition to the wagers placed on each of the wagering events. Alternatively, the game of the present invention may be conducted by the wagering authority with respect to the wagers placed on each of the wagering events without an additional wager being placed or any other action taken by the players.

Payouts for winning tickets for the high-level game may be based on predetermined odds that do not change during the period of time when wagers may be placed. Alternatively, payouts for winning tickets of the high-level game may be determined on a parimutuel basis. A parimutuel wagering scheme includes a betting pool in which players who place wagers share the total amount bet by all players, minus a percentage retained by the wagering authority. Such a scheme allows payouts to winning players to change throughout the period of time when wagers may be placed, while the players are placing their wagers. The payout to players who place winning wagers depends on the number of players that place winning wagers and the number of players that place non-winning wagers. In such a parimutuel wagering scheme, players may be apprised of the changing payouts for the various possible wagers throughout the period of time when wagers may be placed. In particular, the payout to a player for a winning wager may be determined at the time the wager is placed. Accordingly, payouts will be higher for wagers that are chosen by fewer players than those chosen by the other remaining players. Thus, players are encouraged to place wagers on the less popular wagers that provide higher payouts. Such a scheme tends to stabilize the payout to players that place winning wagers because the players' wagers are more evenly distributed among the possible wagers.

The game of the present invention may be applied to any series of outcome-determining, order-dependent wagering events on which wagers may be placed, such as a racing game or any ranking scheme including a series of sporting events for sports teams such as football, soccer and basketball games.

Moreover, the wagers placed on the wagering events need not be limited to wagers relating to the “winner” of the event. For example, wagers may be placed for a particular racehorse to win, place or show in a race.

The wagering game of the present invention may be implemented as an electronic video or computer game to be played in a casino or other gaming establishment or even in a remote location, such as a player's home. The game may also be played via an electronic communication network, such as a local area network, a wide area network, or the internet.

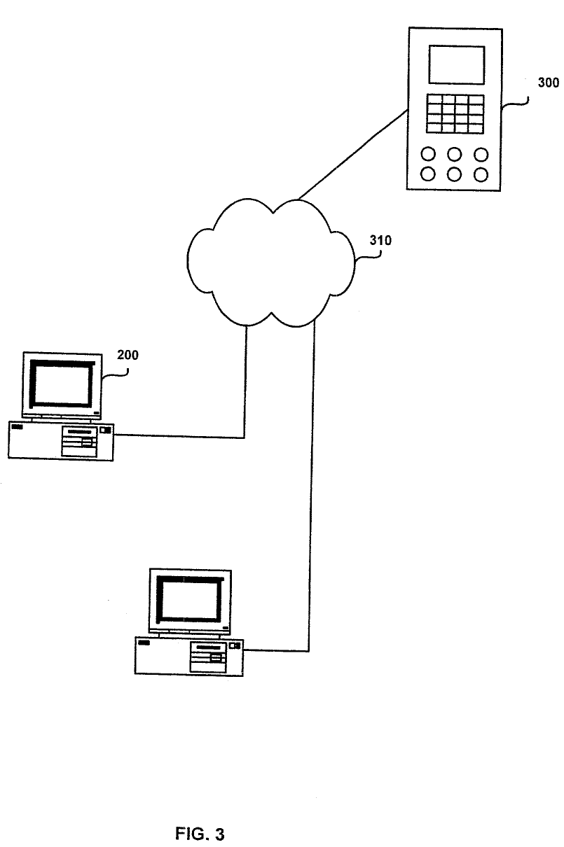

FIG. 3 shows a series of game machines, including game machine 200, in communication with a central processor 300 over a network 310 such as the internet. Central processor 300 determines the outcomes of the series of sequential wagering events, and after each outcome, compares players' wagers to the outcome and determines whether an uneliminated wager placed at game machine 200 is the only uneliminated wager for the last wagering event for which the outcome was determined.

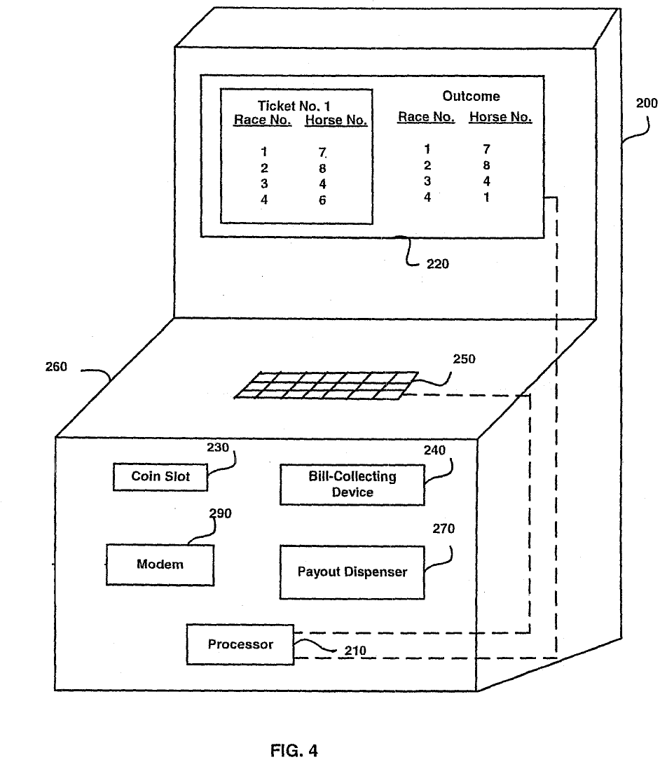

As shown in FIG. 4, electronic game machine 200 may include a processor 210. The player views a display device or screen 220 showing a series of wagering events and their outcomes. A player may play the game of the present invention at game machine 200 by inserting a predetermined amount of money into a coin slot 230 or a bill-collecting device 240. Once the predetermined amount of money has been inserted, the game commences and is displayed to the player on screen 220. Communications between game machine 200 and central processor 300 may be accomplished, e.g., using a modem 290 in game machine 200 that transmits data over the public telephone network or by communication over a network, such as a local area network, a wide area network, or the internet.

Before processor 210 shows and determines the outcomes of the series of wagering events, the player places wagers on a series of sequential wagering events using data entry device or keyboard 250 on console 260 or by touching a touch-sensitive screen 220. Processor 210 then determines the outcomes of the wagering events, and determines whether the player's wagers are eliminated or uneliminated from the high-level game based on the winning status of each of the player's wagers compared to the outcomes of the sequential wagering events. After the outcome of each wagering event is determined, central processor 300 determines whether the player is the winner of the high-level game.

If the player is the winner of the high-level game, the player may be awarded a prize. For example, the game machine 200 may either dispense a monetary prize to the player through a payout dispenser 270 or credit an account maintained by processor 210 against which the player may play further games on game machine 200. Payouts determined on a parimutuel basis are possible when multiple players play the same game at similar game machines in communication with game machine 200.

Other embodiments are within the scope of the following claims.

What is claimed is:

1. A method of playing a game based on outcomes of multiple sequential wagering events, comprising:
placing wagers on the outcomes of the sequential wagering events;
determining the outcomes of a plurality of the wagering events;
determining whether the wagers have a winning status for each of the plurality of the wagering events; and
determining whether the wagers are the only wagers placed on the outcomes of the sequential wagering events having a winning status for all of the plurality of the wagering events.

2. The method of claim 1 further comprising
awarding a prize if the wagers are the only wagers placed on the outcomes of the sequential wagering events having a winning status for all of the plurality of the wagering events.

3. The method of claim 2 wherein the prize is based on predetermined odds.

4. The method of claim 2 wherein the prize is determined on a parimutuel basis.

5. The method of claim 1 further comprising
placing a monetary wager on the game.

6. The method of claim 1, further comprising
recording the wagers on a ticket.

7. The method of claim 1 wherein the wagering events are horse races.

8. A method of playing a game based on outcomes of multiple sequential wagering events, comprising:
placing wagers on the outcomes of the sequential wagering events;
determining the outcomes of a plurality of the wagering events including a final wagering event;
determining whether the wagers have a winning status for each of the plurality of the wagering events including the final wagering event; and
awarding a prize if the wagers have a winning status for each of the plurality of the wagering events including the final wagering event.

9. A method of playing a game based on outcomes of sequential wagering events, comprising:
placing wagers on the outcomes of the sequential wagering events;
determining the outcome of one of the wagering events; and
determining whether the wager placed on the wagering event with the determined outcome has a winning status, and
if the wager does not have a winning status for the determined outcome, eliminating the wagers from the game, or
if the wager has a winning status for the determined outcome,
concluding the game if the wager is the only wager having a winning status for the determined outcome, or
determining the outcome of the next sequential wagering event if the wager is not the only wager having a winning status for the determined outcome.

10. The method of claim 9 further comprising
awarding a prize if the game is concluded.

11. The method of claim 10 wherein the prize is based on predetermined odds.

12. The method of claim 10 wherein the prize is determined on a parimutuel basis.

13. The method of claim 9 further comprising
recording the wagers on a ticket.

14. The method of claim 9 wherein the wagering events are horse races.

15. An electronic gaming device for playing a game based on outcomes of multiple sequential wagering events by a player, comprising:
an input device by which the player places wagers on the outcomes of the sequential wagering events;
a processor for determining the outcomes of a plurality of the wagering events, determining whether the wagers have a winning status for each of the plurality of the wagering events, and determining whether the wagers are the only wagers placed on the outcomes of the sequential wagering events having a winning status for all of the plurality of the wagering events and
a display device for displaying the outcomes of the plurality of the wagering events.

16. The electronic gaming device of claim 15 wherein the display device comprises a screen.

17. The electronic gaming device of claim 15 wherein the input device comprises a keyboard.

18. The electronic gaming device of claim 15 wherein the input device comprises a touch-sensitive screen.

19. The electronic gaming device of claim 15 further comprising
a payout device for providing a prize to the player.

20. A system for playing a game based on outcomes of multiple sequential wagering events by a player, comprising:
a gaming device by which the player places wagers on the outcomes of the sequential wagering events; and
a central processor for determining the outcomes of a plurality of the wagering events, determining whether the wagers have a winning status for each of the plurality of the wagering events, and determining whether the wagers are the only wagers placed on the outcomes of the sequential wagering events having a winning status for all of the plurality of the wagering events.

21. The system of claim 20 wherein the gaming device communicates with the central processor over a network.

22. The system of claim 21 wherein the network is the internet.

23. The system of claim 20 further comprising a modem by which the gaming device communicates with the central processor.
